(19) United States
(12) Patent Application Publication
(10) Pub. No.: US 2003/0118025 A1
(43) Pub. Date: Jun. 26, 2003

(54) Method of aggregation link information in the private network-to-network interface

(75) Inventor: Dong Won Lee, Anyang-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/325,865

(22) Filed: Dec. 23, 2002

(30) Foreign Application Priority Data
Dec. 24, 2001 (KR) 2001-84196

(51) Int. Cl. H04L 12/28

(52) U.S. Cl. 370/395.1

(57) ABSTRACT

A method for aggregating link information in a PNNI routing protocol comprises determining links in a first protocol layer having a same token value in a PNNI routing block, and aggregating the links into a link of a second protocol layer, wherein the second protocol layer is a higher layer than the first protocol layer.

### BACKGROUND OF THE INVENTION

1. Field of the Invention

The present invention relates to communicating information over a network, and more particularly to a system and method of aggregating link information in a Private Network-to-Network Interface (PNNI) system.

2. Background of the Related Art

The PNNI protocol is a protocol established at the Asynchronous Transfer Mode Forum. The PNNI protocol is used to communicate information within a network formed by connecting a number of private network providers.

The PNNI protocol comprises a routing protocol and a signaling protocol. The routing protocol supports dynamic routing (including a dynamic route choice method) and multi-layers. In order to operate the routing protocol, the PNNI protocol includes nodes and links which perform basic PNNI functions. The PNNI protocol also sets initial values of the nodes and links. Node information includes node addresses, node ATM End System Addresses (AESA), and node Peer Group Identities (PGID). Link information includes a port ID value of each link, administrative weight, link aggregation token for link aggregation at a multi-layer system, and resource information of each link.

If a protocol is operated with node information and link information, the PNNI routing exchanges information dynamically and manages information of partner nodes. Information exchanged in this manner is called topology information, which is to be distinguished from the initial configuration information. Topology information is used for performing dynamic routing when the signaling protocol is required.

In the related art, only methods focusing on aggregating links have been provided. No method has been proposed for aggregating link information needed for dynamic routing, which is required to actually perform a call while aggregating a number of links of a lower layer and expressing them at a higher layer. As a result, there have been problems of high load in multi-layer routing and a great possibility of call failure because the information to be transmitted would not be determined at the time of choosing routes or during the performance of routing between higher layers.

### SUMMARY OF THE INVENTION

One object of the present invention is to provide an improved system and method for aggregating link information over a network.

Another object of the present invention is to achieve the aforementioned object by providing a system and method which manages links of a lower layer needed for multi-layer processing in a PNNI routing protocol at a higher layer, by aggregating links of a lower layer faster and more efficiently than other proposed methods.

Another object of the present invention is to achieve the aforementioned object by handling a large amount of link information needed for performing an actual call function that is handled by other proposed methods.

Another object of the present invention is to provide a system and method which implements a higher layer of PNNI routing by effectively aggregating link information of outside links of a lower layer, which affect a PNNI call function in the PNNI routing protocol at a horizontal link of a higher layer, thereby making multi-layer routing possible and minimizing call failure.

Another object of the present invention is to provide a system and method which performs a PNNI multiplayer routing operation in a manner which minimizes routing load and performs dynamic information exchange successfully by using a Significant Change Algorithm.

In order to achieve these and other objects, the present invention provides a link information aggregation method which performs a link information implementation process that aggregates link information of outside links, having the same aggregation token value in a PNNI routing block, at a relevant horizontal link when aggregating the outside links of a lower layer into a horizontal link of a higher layer in order to perform the PNNI protocol.

Preferably, the link information comprises link port ID for the relevant link, administrative weight, link aggregation token for link aggregation at multi-layer system, maximum cell rate that indicates the bandwidth of the overall link, available cell rate that indicates an available bandwidth, cell transfer delay, cell delay variance and service category.

The link information implementation process preferably comprises the steps of: setting the service category of the horizontal link to include all service categories for outside links having the same aggregation token value; setting the administrative weight of the horizontal link with the minimum value of the administrative weights of the outside links having the same aggregation token value; setting the available cell rate of the horizontal link with the maximum value of available cell rates of the outside links having the same aggregation token value; and setting the maximum cell rate of the horizontal link with the maximum cell rate of the outside link, whose available cell rate is the maximum, of the outside links having the same aggregation token value.

The PNNI link information aggregation method of the present invention may further comprise a link information change handling process that applies a Significant Change Algorithm to changes of link information of the outside links having the same aggregation token and, when a change of information over a certain range occurs, utilizes the change of link information as the information of the horizontal link and transmits the relevant information to other neighbor nodes.

The link information change handling process preferably applies the Significant Change Algorithm in order to minimize routing load when a change of available cell rates of the outside links, which could affect the available cell rate of the horizontal link, is over a certain range.

The link information change handling process preferably comprises the steps of comparing the previous link information value and the current link information value by applying the Significant Change Algorithm to each of the link information of the outside links having the same aggregation token value, transmitting the relevant changed link information to other nodes in the peer groups of the lower layer when the difference between the previous link information value and the current link information value is over a certain percent predetermined by an administrator, reporting the change of the link information at the Peer Group Leader (PGL) in the peer group of a lower layer to a Logical Group Node (LGN) of a higher layer and transmitting and receiving the changed and aggregated link information through the higher routing protocol between other higher nodes, and transmitting the link information, aggregated and transmitted/received between the higher nodes, to the PGL in the peer group of the lower layer and transmitting the relevant aggregated link information from the relevant PGL to other nodes in the peer group of the lower layer.

According to one embodiment, the link information includes an available cell rate indicating the currently available bandwidth.

According to another embodiment, a PNNI link information aggregation method according to the present invention comprises: a link information implementation process that aggregates link information of outside links, having the same aggregation token value in a PNNI routing block, at the relevant horizontal link when aggregating the outside links of a lower layer into a horizontal link of a higher layer in order to perform the PNNI protocol; and a link information change handling process that applies the Significant Change Algorithm to a change of available cell rates of the outside links and, when the change is over a certain range, utilizes the change of the available cell rate as information of the horizontal link and transmits the relevant information to other neighbor nodes. Preferably, the link information preferably comprises any one or more of service category, administrative weight, maximum cell rate indicating a bandwidth of the overall link, and an available cell rate that indicates the available bandwidth.

According to another embodiment, the link information implementation process comprises the steps of setting the service category of the horizontal link to include all service categories of the outside links, setting the administrative weight of the horizontal link with the minimum value of administrative weights of the outside links, setting the available cell rate of the horizontal link with the maximum value of available cell rates of the outside links, and setting the maximum cell rate of the horizontal link with the maximum cell rate of the outside link, whose available cell rate is the maximum of the outside links.

According to another embodiment, the link information change handling process comprises the steps of: comparing the previous available cell rate and the current available cell rate by applying the Significant Change Algorithm to each of the available cell rates of the outside links; transmitting the relevant changed information to other nodes in the peer group of the lower layer when the difference between the previous value and the current value is over a certain percent predetermined by an administrator; reporting the change of the available cell rate at the PGL in the peer group of a lower layer to the LGN of a higher layer and transmitting and receiving the changed and aggregated information through the higher routing protocol between other higher nodes; and transmitting the aggregated information, transmitted/received between the higher nodes, to the PGL in the peer group of the lower layer and transmitting the relevant aggregated information from the relevant PGL to other nodes in the peer group of the lower layer.

### BRIEF DESCRIPTION OF THE DRAWINGS

FIG. 1 is a block diagram illustrating the structure for the link aggregation in the PNNI according to a preferred embodiment of the present invention.

FIG. 2 illustrates the Significant Change Algorithm applied to a preferred embodiment of the present invention.

FIG. 3 is a flow diagram illustrating the link information aggregation method in the PNNI according to a preferred embodiment of the present invention.

FIG. 4 is a flow diagram illustrating the link information implementation process of FIG. 3.

### DETAILED DESCRIPTION OF PREFERRED EMBODIMENTS

In aggregating links of a lower layer for implementing a PNNI multi-layer routing protocol and processing the links as an aggregated link at a higher layer, the present invention processes one or more of the values of administrative weight, available cell rate, and maximum cell rate that may affect the call function more than other information of the higher aggregated link. The present invention may also use a Significant Change Algorithm for performing PNNI multi-layer routing in order to minimize routing load caused by a change of available cell rate of the higher aggregated link. The various embodiments of the invention will now be described.

According to one embodiment of the link information aggregation method of the present invention implemented using a PNNI routing protocol, nodes having the same peer group identification (PGID) constitute one peer group and nodes in the same peer group exchange information about themselves through a PNNI routing protocol. This information is then stored for use in performing dynamic routing. Also, the link connected to another group having a different PGID may be managed separately as an outside link. The information exchange through the relevant outside link is conducted by a protocol referred to as an Outside Link Hello.

Each peer group is preferably expressed as one node at a higher layer by a node aggregation method and a number of outside links is expressed as one or several aggregated links at a higher layer by the link aggregation method. Also, one node elected by a peer group leader (PGL) election protocol becomes a representative node for the higher layer and a node of a higher layer is referred to as a logical group node (LGN). In other words, a relevant LGN elects a PGL, a representative node, among nodes of a lower peer group at the time of implementing the PNNI multi-layer protocol and the elected node becomes a node of the higher peer group.

An outside link connecting peer groups at a lower layer becomes a horizontal link between LGNs of a higher layer through link aggregation. In other words, a relevant horizontal link means the link, among links connecting nodes in a same peer group, that may sufficiently exchange information about the links through the PNNI routing protocol and thus may be used for processing the call. Also, a higher peer group is formed using the relevant LGNs and aggregated links, and this higher peer group forms another even higher peer group by performing the same process as performed in the lower peer group.

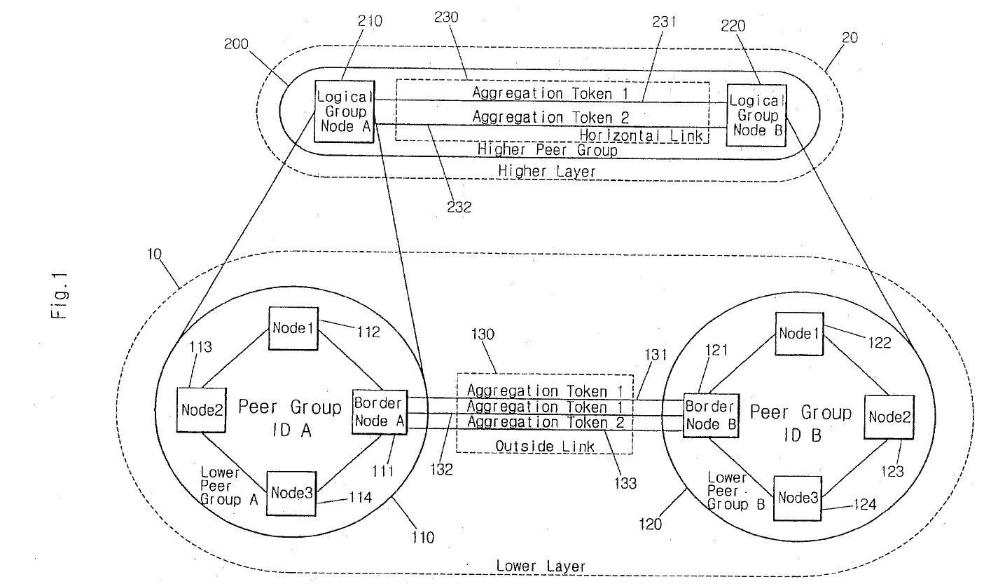

FIG. 1 shows a structure for performing link aggregation in a PNNI multi-layer routing protocol according to a preferred embodiment of the present invention. This structure includes a lower layer (10) and a higher layer (20). The lower layer (10) comprises lower peer group A (110) comprising nodes (111, 112, 113, 114) whose PGID is commonly ‘A’, lower peer group B (120) comprising nodes (121, 122, 123, 124) whose PGID is commonly ‘B’, and outside links (130) connecting the lower peer group A (110) and the lower peer group B (120). The outside links (130) connect the border node A (111) of the lower peer group A (110) and the border node B (121) of the lower peer group B (120). Information exchange through the outside links (130) is preferably conducted using an Outside Link Hello protocol. However, those skilled in the art can appreciate that other link protocols may be used if desired.

The higher layer (20) comprises a higher peer group (200) comprising LGN A (210) elected at the lower peer group A (110) by the PGL election protocol, LGN B (220) elected at the lower peer group B (120) by the PGL election protocol, and horizontal links (230) connecting LGN A (210) and LGN B (220). LGN A (210) is a node that expresses the lower peer group A (110) of the lower layer (10) at the higher layer (20) through node aggregation. LGN B (220) is a node that expresses the lower peer group B (120) of the lower layer (10) at the higher layer (20) through node aggregation. The horizontal links (230) are links that express the outside links (130) of the lower layer (10) at the higher layer (20) through the link aggregation.

In this embodiment, link aggregation is not performed at LGNs (210, 220) of the higher layer (20) but is performed at the border nodes (111, 121) in the lower peer groups (110, 120) of the lower layer (10) having the outside links (130). In order to aggregate the outside links (130), the outside links (131, 132, 133) are respectively provided with an aggregation token. An aggregation token indicates whether the outside links may be aggregated together at the time of aggregating outside links of the lower layer into one or several aggregated links at the higher layer (20). Links having the same aggregation token value are expressed as one link. The aggregation token value may be either a configured aggregation token value or a derived aggregation token value.

A configured aggregation token value is a value which is preferably predetermined by an administrator when the PNNI link is generated. A derived aggregation token value is a token value of the aggregated horizontal links (230), which will be used by the border nodes (111, 121) in different lower peer groups (110, 120) at the higher layer (20) by negotiation while exchanging the configured aggregation token value at the lower layer (10) through the Outside Link Hello protocol after the configured aggregation token is determined.

Each of the border nodes (111, 121) in the lower peer groups (110, 120) may have a different configured aggregation token value for each of the relevant outside links (130) at the lower layer (10). Also, the aggregation token value of the outside links (130) illustrated in FIG. 1 represents the derived token value after the Outside Link Hello protocol has been performed.

The outside links (130) of the lower layer (10) include outside links (131, 132) having the derived token value ‘1’ and an outside link (133) having the derived token value ‘2’. Outside links (131, 132) that have the same derived aggregation token value are expressed as one horizontal link (231) in the higher peer group (200) of the higher layer (20) by the link aggregation.

More specifically, the horizontal links (230) of the higher layer (20) include a horizontal link (231) that has an aggregation token value ‘1’ and a horizontal link (232) that has a relevant aggregation token value ‘2’. The horizontal link (231) whose aggregation token value is 1 is the link aggregating and expressing the two outside links (131, 132) that have the derived token value ‘1’, among the outside links (130) of the lower layer (10). The horizontal link (232) whose aggregation token value is ‘2’ is the link expressing, without aggregating, the outside link (133) having the derived token value ‘2’ among the outside links (130) of the lower layer (10).

As previously described, the PNNI routing protocol is preferably performed when the outside links (131, 132) of the lower layer (10) having the same derived aggregation token value become the horizontal link (231) of the higher layer (20) through the link aggregation. Information exchanged between the LGNs (210, 220) of the higher layer (20) is used at the time of requesting a route of the signaling protocol.

At a higher layer (20), the higher peer group (200) is formed by using LGN A (210), LGN B (220), and the horizontal links (230). At the higher peer group (200), the same method used in the lower peer groups (110, 120) of the lower layer (10) is performed to form another peer group at a layer even higher than the higher layer (20).

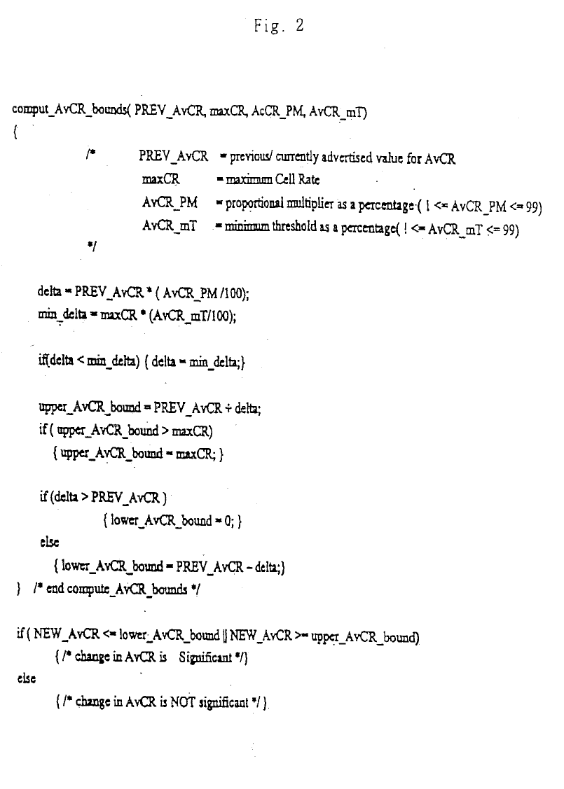

FIG. 2 shows a Significant Change Algorithm to which the present invention is applied. This Significant Change Algorithm processes changed information only when information is changed by an amount which exceeds a predetermined level. By applying the Significant Change Algorithm to each of the links of the lower layer (10), only if information is changed over a certain extent, the relevant changed information is given to other nodes (111-114, 121-124) in the lower peer groups (110, 120). The threshold extent of the information change may be determined and set by the administrator.

Also, by applying the Significant Change Algorithm to each of the outside links (130) connecting the border nodes (111, 121) in the lower peer groups (110, 120), only if information is changed over a certain extent, the relevant changed information is given to other nodes (111˜114, 121˜124) in the lower peer groups (110, 120).

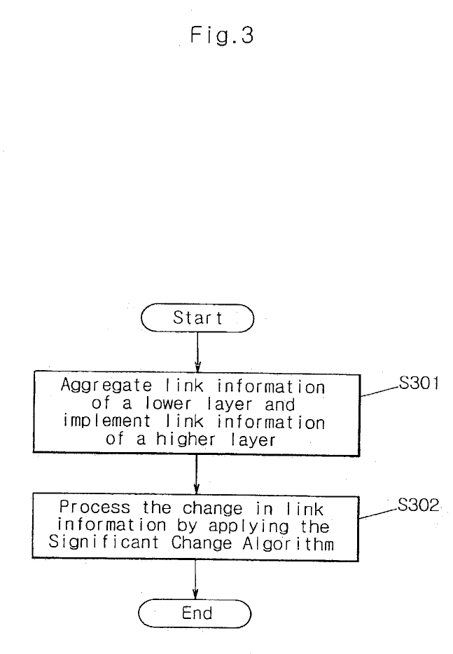

FIG. 3 is a flow diagram showing steps included in a link information aggregation method according to an embodiment of the present invention. Firstly, for the link aggregation that aggregates the outside links (130) of the lower layer (10) having the same aggregation token value and expresses the aggregated links as the horizontal links (230) of the higher layer (20) for the performance of the PNNI protocol, a PNNI routing block (not illustrated for convenience) performs a link information implementation process in which link information of the outside links (130) of the lower layer (10) is aggregated at the horizontal links (230) of the higher layer (20) (S301). The PNNI routing block is a block that manages and processes link information for generally conducting multi-layer PNNI routing.

The link information includes one or more of a port ID for the relevant link, an administrative weight which is a weighted value of the administrator, a link aggregation token for link aggregation at a multi-layer system, a maximum cell rate indicating bandwidth of the overall link, an available cell rate indicating a currently available bandwidth, a cell transfer delay, a cell delay variance, and a service category.

Because the link information is ultimately used for performing a call, aggregation of link information such as service category, administrative weight, available cell rate, and the maximum cell rate, which are the factors greatly affecting the PNNI call performance, becomes very important as such aggregation is closely related to performance. In contrast, other link information does not have much influence on the call performance or the routing. Thus, the information aggregated at the horizontal links (230) of the higher layer (20) is preferably the following information: service category, administrative weight, available cell rate and the maximum cell rate.

Secondly, the Significant Change Algorithm is applied with respect to change of the available cell rate of the horizontal link (231) of the higher layer (20), among the link information for the outside links (130) of the lower layer (10) exchanged dynamically by the PNNI routing block while the PNNI routing is performed. Here, a link information change handling process is performed only if the available cell rate has been changed over a predetermined extent (S302).

The link information change handling process (S302) informs the higher peer group (200) of the higher layer (20) of occurrence of information change over a predetermined extent by applying the Significant Change Algorithm. This occurs under two conditions: (1) if there is a change in the available cell rate of the outside link whose available cell rate is the greatest among the outside links (131, 132) of the lower layer (10) aggregated with the same aggregation token value, or (2) if there is any other change which might affect the available cell rate of the horizontal link (231) of the higher layer (20).

The reason why the Significant Change Algorithm is applied to the available cell rate is described as follows. The available cell rate changes constantly in accordance with on/off status of the call. Thus, the available cell rate of the outside link whose available cell rate is the highest of the outside links (131, 132) of the lower layer (10) aggregated with the same aggregation token may change all the time and the value of the cell rate changes accordingly. Given the foregoing, if any change of the value were to be set as the available cell rate of the horizontal link (231) of the higher layer (20) every time the relevant cell rate changes, the information about the frequent change must be notified to the neighbor nodes all the time and, consequently, routing load would be very large.

Therefore, in the present invention, a link information change handling process is performed only if a change of the available cell rate over a predetermined extent occurs, and this information is used for the information of the horizontal link (231) of the higher layer (20), through the Significant Change Algorithm for change of the available cell rate of the outside links (131, 132) of the lower layer (10) aggregated with the same aggregation token value. Then, the node of the higher layer (20) transmits the relevant information to the neighbor nodes.

In other words, the link information change handling process (S302) applies the Significant Change Algorithm to changes of the available cell rate of the aggregated horizontal link (231). Likewise, the Significant Change Algorithm is applied to each of the outside links (131, 132) of the lower layer (10), aggregated with the same aggregation token value. Thus, the current value is compared with the previous value, and if the change is over a certain percentage predetermined by the operator, the other nodes in the lower peer groups (110, 120) are informed of the relevant changed information.

Also, the available cell rate of the horizontal link (231) is changed only if the difference between the available cell rate of the previous horizontal link (231) and the highest available cell rate between the current outside links (131, 132) is above a certain range predetermined by the administrator. This is made possible by applying the Significant Change Algorithm to changes at the outside links (131, 132) connecting the border nodes (111, 121), and this is performed even if there is a change in the value of the link having the highest available cell rate between the outside links (131, 132) of the lower layer (10) which have the same aggregation token value, expressed as one aggregated horizontal link (231) in the higher layer (20).

In this manner, whenever a change of information of the outside links (131, 132) occurs, the relevant-changed information is transmitted in the border nodes (111, 121) from a resource managing function block to the PNNI routing protocol, and when it is determined that the relevant changed information needs to be transmitted the relevant PNNI routing protocol transmits the relevant information to all nodes in the peer group (110, 120). Further, the PGLs in the lower peer groups (110, 120) transmit the change of the relevant information to the LGNs (210, 220) of the higher layer (20).

Thereafter, the determined value mentioned above or link information changed later are exchanged among other higher nodes through the higher routing protocol. The higher nodes transmit the exchanged information to the PGLs in the lower peer groups (110, 120) and the PGLs transmit the higher aggregated link information to all nodes in the lower peer groups (110, 120).

Thus, the call is conducted if there is a call request in the signaling protocol, relying only on the information of all nodes in the lower peer groups (110, 120). Also, at this time, if there is a change over a predetermined extent in the available cell rate among the higher aggregated link information, the relevant-changed information is exchanged between the higher nodes again through the Significant Change Algorithm and the relevant information is transmitted to the lower nodes again. Any request for a call afterwards is managed by applying the relevant changed information.

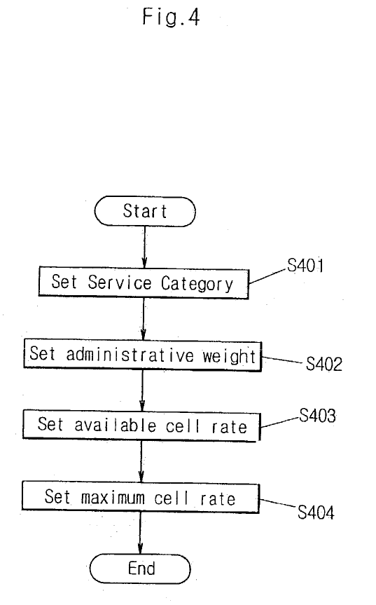

FIG. 4 is a flow diagram showing steps included in a link information implementation process (S301) in accordance with one embodiment of the present invention. First, the PNNI routing block sets the service category of the horizontal link (231) of the higher layer (20) so that it may include all service categories of the outside links (131, 132) of the lower layer (10), aggregated with the same aggregation token value (S401).

Then, in order to implement the link information corresponding to the respective service categories of the lower layer (10), the PNNI routing block sets the administrative weight of the horizontal link (231) of the higher layer (20) with the minimum value of administrative weights of the outside links (131, 132) of the lower layer (10), aggregated with the same aggregation token value (S402).

At this time, the administrative weight has much influence on the route choice. Preferably, the administrative weight is set with the minimum value as described above. This is performed so that the PNNI gives priority on the route, of which the sum of the administrative weight is the minimum, at the time of choosing a call route.

Next, the PNNI routing block sets the available cell rate of the horizontal link (231) of the higher layer (20) with the maximum value of available cell rates of the outside links (131, 132) of the lower layer (10), aggregated with the same aggregation token value (S403).

The available cell rate also influences the route choice as does the administrative weight. The reason why the available cell rate is set with the maximum value as described above is that, by this manner, the PNNI may reduce the rate of call failures caused by bandwidth requested by the call most effectively at the time of processing a call.

Thus, the PNNI routing block sets the maximum cell rate of the horizontal link (231) of the higher layer (20) with the maximum cell rate of the outside link which has the maximum available cell rate of the outside links (131, 132) of the lower layer (10), aggregated with the same aggregation token value (S404). The maximum cell rate means the maximum value which a link has itself, and the reason why the maximum cell rate is set as described above is to apply the Significant Change Algorithm when the available cell rate changes.

In summary, the present invention makes it possible to effectively implement a higher layer of the PNNI routing by aggregating link information of outside links of a lower layer which affects PNNI call performance. The invention also performs dynamic information exchange successfully by minimizing the routing load by applying the Significant Change Algorithm to the PNNI multi-layer routing operation. The present invention is advantageously applicable to the nationwide ATM switching system and to all ATM systems adopting the PNNI multi-layer protocol in the future.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for aggregating link information in a PNNI routing protocol, comprising:
(a) determining links in a first protocol layer having a same token value in a PNNI routing block; and
(b) aggregating said links into a link of a second protocol layer, wherein the second protocol layer is a higher layer than the first protocol layer.

2. The method of claim 1, wherein the aggregating step includes: aggregating link information of the links in the first protocol layer, said link information including at least one of a link port ID, an administrative weight, a link aggregation token for a link aggregation at a multi-layer system, a maximum cell rate that indicates a bandwidth of an overall link, an available cell rate that indicates an available bandwidth, a cell transfer delay, a cell delay variance and a service category.

3. The method of claim 1, wherein the aggregating step includes:
setting a service category of the link in the second protocol layer to include service categories of the links in the first protocol layer having the same token value;
setting an administrative weight of the link in the second protocol layer with a minimum value of administrative weights of the links in the first protocol layer having the same token value;
setting an available cell rate of the link in the second protocol layer with a maximum value of available cell rates of the links in the first protocol layer having the same token value; and
setting a maximum cell rate of the link in the second protocol layer with a maximum cell rate one of the links in the first protocol layer having a maximum available cell rate.

4. The method of claim 1, further comprising:
(a) applying a Significant Change Algorithm to change link information of the links in the first protocol layer having the same token value; and
(b) modifying information of the link in the second protocol layer based on the changed link information when the changed link information exceeds a predetermined amount; and transmitting information to at least one neighbor node.

5. The method of claim 4, wherein the Significant Change Algorithm is applied in order to minimize a routing load when a change of available cell rate of the links in the first protocol layer exceeds a certain range.

6. The method of claim 4, wherein step (a) includes:
comparing a previous link information value and a current link information value by applying the Significant Change Algorithm to link information for each of the links in the first protocol layer having the same aggregation token value;
transmitting changed link information to at least one other node in peer groups of the first layer when a difference between the previous link information value and the current link information value is over a predetermined value;
reporting a change of the link information at a Peer Group Leader (PGL) in a peer group of the first protocol layer to a Logical Group Node (LGN) of the second protocol layer and transmitting and receiving the changed and aggregated link information through the second protocol layer between other higher nodes; and
transmitting the link information, aggregated and transmitted/received between the higher nodes, to the PGL in the peer group of the first protocol layer and transmitting the relevant aggregated link information from the relevant PGL, to other nodes in the peer group of the first protocol layer.

7. The method of claim 6, wherein the link information includes an available cell rate indicating a currently available bandwidth.

8. A link information aggregation method, comprising:
aggregating links in a first protocol layer having the same aggregation token value in a PNNI routing block into a link in a second protocol layer, wherein the second protocol layer is higher than the first protocol layer; and
applying a Significant Change Algorithm to change available cell rates of the links in the first protocol layer, and modifying information corresponding to the second protocol layer when the change is over a certain range.

9. The method of claim 8, wherein the link information includes at least one of a service category, an administrative weight, a maximum cell rate that indicates bandwidth of an overall link, and an available cell rate that indicates an available bandwidth.

10. The method of claim 8, wherein aggregating step includes:
setting a service category of the link in the second protocol layer to include service categories of the links in the first protocol layer;
setting an administrative weight of the link in the second protocol layer with a minimum value of administrative weights of the links in the first protocol layer;
setting an available cell rate of the link in the second protocol layer with maximum value of available cell rates of the links in the first protocol layer; and
setting a maximum cell rate of the link in the second protocol layer with a maximum cell rate of at least one of the links in the first protocol layer.

11. The method of claim 8, wherein applying step includes:
comparing a previous available cell rate and a current available cell rate by applying the Significant Change Algorithm to each of the available cell rates of the links in the first protocol layer;
transmitting changed information to at least one other node in a peer group of the first protocol layer when a difference between the previous value and current value exceeds a predetermined value;
reporting a change of available cell rate at a Peer Group Leader PGL in the peer group of the first protocol layer to a Logical Group Node LGN of the second protocol layer, and transmitting and receiving the changed and aggregated information through the second protocol layer between other higher nodes; and
transmitting the aggregated information, transmitted/received between the higher nodes, to the PGL in the peer group of the first protocol layer and transmitting the relevant aggregated information from the relevant PGL to other nodes in the peer group of the first protocol layer.
